(19) United States
(12) Patent Application Publication
(10) Pub. No.: US 2007/0028298 A1
(43) Pub. Date: Feb. 1, 2007

(54) System and method for configuring an electronic device

(76) Inventors: Helaine Snyder, Lake Worth, FL (US); Neil Kleinberg, Commack, NY (US); Bret Weiss, Shirley, NY (US); Judith Murrah, St. James, NY (US)

Correspondence Address: FAY KAPLUN & MARCIN, LLP, 15O BROADWAY, SUITE 702, NEW YORK, NY, 10038, US

(21) Appl. No.: 11/193,650

(22) Filed: Jul. 29, 2005

(51) Int. Cl. H04L 9/32; H04L 9/00; G06F 12/14; G06F 15/16; G06K 9/00; G06F 11/30; G06F 17/30; G06F 7/04; G06F 7/58; G06K 19/00

(52) U.S. Cl. 726/3; 726/4; 713/153; 713/192

(57) ABSTRACT

Described is a network switch which includes a communication arrangement, a memory arrangement and a processor. The communication arrangement allows the switch to communicate with a plurality of wireless access ports. The memory arrangement stores an identifier for the switch and access data corresponding to a first number of the access ports. The processor allows communications with the communication arrangement only for the first number of the access ports. The processor allows communications with the communication arrangement by a second number of the access ports only upon receipt and validation of an upgrade access data which corresponds to the second number and the identifier.

### BACKGROUND INFORMATION

Upgradeability is an important aspect to both a consumer and a manufacturer of an electronic device. By extending a lifetime of the device rather than having the consumer purchase a newer version of the device, an upgrade can create significant cost-savings to the consumer. The manufacturer and its distributors and resellers also benefits from not having to produce many versions of the device.

One conventional method for upgrading the device requires the consumer to purchase a physical add-on which is installed onto the device. However, the installation is typically complex and time-consuming, and may adversely affect performance of the device. Thus, the manufacturer often produces the newer version of the device which features a functionality that the add-on would have provided. Therefore, there is a need for a method of upgrading devices which is user-friendly and less time-consuming.

### SUMMARY OF THE INVENTION

The present invention relates to a network switch which includes a communication arrangement, a memory arrangement and a processor. The communication arrangement allows the switch to communicate with a plurality of wireless access ports. The memory arrangement stores an identifier for the switch and access data corresponding to a first number of the access ports. The processor allows communications with the communication arrangement only for the first number of the access ports. The processor allows communications with the communication arrangement by a second number of the access ports only upon receipt and validation of an upgrade access data which corresponds to the second number and the identifier.

### BRIEF DESCRIPTION OF THE DRAWINGS

FIG. 1 is an exemplary embodiment of a system according to the present invention;

FIG. 2 is an exemplary embodiment of a method according to the present invention;

FIG. 3 is an exemplary embodiment of an online form according to the present invention;

FIG. 4 is an exemplary embodiment of another method according to the present invention; and

FIG. 5 is another exemplary embodiment of the system of FIG. 1 according to the present invention.

### DETAILED DESCRIPTION

The present invention may be further understood with reference to the following description and the appended drawings, wherein like elements are provided with the same reference numerals. The present invention provides a system and a method for configuring an electronic device. An exemplary embodiment of the present invention will be described with reference to an upgrade of a network switch, however, one skilled in the art would understand that the present invention is not limited to switches, but may be utilized in configuring other types of electronic devices such as, for example, data storage arrangements, routers and mobile units. For example, a user of the mobile unit could obtain identification data for the device, and based on that data, the mobile unit may enable/disable functions corresponding to the data (e.g., security, software applications, etc.).

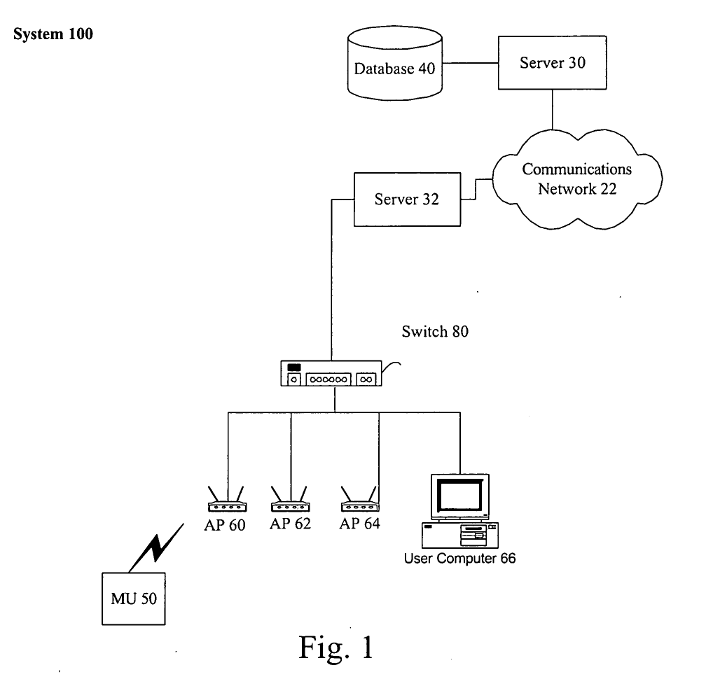

FIG. 1 shows an exemplary embodiment of a system 100 according to the present invention. The system 100 may include a communications network 22 (e.g, wired/wireless WAN/LAN) which facilitates transfer of data between devices coupled thereto. The network 22 may also be in communication with one or more access ports (“APs”) 60,62,64 and one or more user computers, such as a mobile unit “MU” 50 and/or a user computer 66, via a network switch 80 or any other network device (e.g., a router, a hub, etc.). The network 22 may further be coupled to servers 30 and 32. The MU 50 may access the servers 30,32 via the APs 60-64, the switch 80 and the network 22. In one embodiment, the server 32 may not be coupled directly to the network 22, but may have access thereto via the switch 80.

According to an exemplary embodiment of the present invention, the server 30 may be a transactional server responsible for receiving and processing requests for upgrades, and may be coupled to a database 40. The server 32 may be a client server responsible for performing network administration functions (e.g., executing the upgrade) on a client network (e.g., server 32, switch 80, APs 60-64, user computer 66 and/or MU 50). The servers 30,32 may be any computing devices capable of processing data requests (e.g., a mainframe, a dedicated desktop, etc.). Each server 30,32 may include a hardware port (e.g., USB, serial, Ethernet, etc.) for coupling to the network 22, a processor (e.g., a microprocessor), and one or more storage arrangements (e.g., a hard drive, a memory, etc.).

The database 40 may include any type of storage arrangement (e.g., a memory, a hard drive, etc.) and may be located external or internal to the server 30. For example, the database 40 may be an external hard drive, or the database 40 may be located on a computing device coupled to the server 30. In another embodiment, the database 40 may be an internal hard drive disposed within server 30. Thus, the database 40 may be either a primary storage device of the server 30 (e.g., an internal drive), or a secondary storage device (e.g., an external drive). The database 40 may store data relating to a user of the MU 50 (e.g., customer records, billing information, etc.) and/or information regarding the switch 80. The data and information may be utilized by the server 30 to process an upgrade request, which will be described below.

The switch 80 may be coupled to the APs 60-64 and/or the user computer 66 via a communication arrangement (e.g., a plurality of ports) and/or a further switch (not shown) which functions as a relay between the switch 80 and the APs 60-64. That is, the further switch may increase a number of APs in communication with the switch 80. Each port may include any type of hardware arrangement which receives the corresponding AP 60-64 via a wired connection. For example, the ports may be Ethernert ports, USB ports, serial ports, etc. The switch 80 may further include a hardware arrangement (e.g., a USB port, a serial port, an Ethernet port, etc.) for coupling to the network 22. The switch 80 may also include a processor (e.g., a microprocessor) and a storage arrangement (e.g., a memory, a hard drive, etc.).

The MU 50 may be any mobile computing device (e.g., a cell phone, a PDA, a laptop, a network interface card, etc.) which communicates wirelessly with the APs 60-64. For example, the MU 50 may include a wireless transmitter and a wireless receiver to transmit/receive signals to/from the APs 60-64 according to a wireless protocol (e.g., an IEEE 802.11 protocol). The MU 50 may include a scanning arrangement for reading data. For example, the scanning arrangement may be a laser-based or image-based scanner or an RFID interrogator. The MU 50 may further include additional circuitry (e.g., a keypad, a display, a microprocessor, a memory, etc.) enabling it to receive and process instructions.

The APs 60-64 may be coupled to the switch 80 and provide wireless access to the network 22 for the MU 50. For example, each of the APs 60-64 may include a wireless communications arrangement (e.g., a wireless transmitter, a wireless receiver, an antenna, etc.) enabling the APs 60-64 to communicate with the MU 50 according to the wireless protocol. The APs 60-64 may further include a hardware arrangement for coupling to the ports of the switch 80. For example, the hardware arrangement may include one or more input/output (“I/O”) ports (e.g., USB, serial, Ethernet, wireless, etc.) and one or more I/O controllers (e.g., a controller card, a processor, etc.).

In the exemplary embodiment of the present invention, the switch 80 may be manufactured to include a capability to support additional functionality corresponding to the upgrade request. For example, when the switch 80 is sold to the user, it may include access data for supporting a predetermined total of APs (e.g., 30 APs), with a first subset thereof enabled (e.g., 6 APs). That is, a remaining number (e.g., 24) of APs may be capable of being supported, but they are disabled and do not provide an active connection (i.e., cannot perform a predetermined operation). A user who wishes to enable one or more of the remaining number of APs may do so by using one or more upgrade certificates (e.g., a permission to upgrade, an upgrade license, etc.) to perform the upgrade request, which will be described below.

The certificate may be purchased along with the switch 80, and additional certificates may be purchased directly from the manufacturer or any authorized third party (e.g., a reseller). The certificate may allow the user to enable a predetermined number of additional APs (e.g., 1-n) from the remaining number of APs (e.g., 24 ports) which are disabled. A current number of APs currently supported by the switch 80 may be stored in the database 40. The current number may correspond to the certificate(s) which have been assigned to the switch 80. For example, the switch 80 may support up to 30 APs. However, when purchased, the switch 80 supports only 6 APs. Thus, the total number is 30 and the current number is 6. Using the certificate, the current number may be increased to equal, but not exceed, the total number.

In another embodiment, when the switch 80 is purchased, it may not currently support any APs. That is, the current number is zero. Thus, the user may obtain at least one certificate in order to render the switch 80 operational. When the current number is zero, the switch 80 may be utilized as the further switch described above, i.e., a relay.

As described above, the switch 80 may be prepackaged with the current number being greater than zero, allowing the user to operate the switch 80 immediately. The certificate may include a first data (e.g., a unique identifier which corresponds to a number of APs that will be enabled by the certificate), which when combined with a second data (e.g., a serial number and/or MAC address of the switch 80), may generate a third data (e.g., an upgrade access data). The first data may be embodied as a certificate code on the certificate, and the third data may be a predetermined key which when received by the switch 80, enables the number of APs indicated by the certificate code. As understood by those of skill in the art, the certificate and the serial number are merely exemplary embodiments of sources of the first and second data.

As an example, the certificate code may have the unique identifier “101” which provides for enablement of 6 APs. That is, if the upgrade is successful, the current number will be increased by 6, and that certificate may not be used again. When the certificate code is combined with the serial number or MAC address of the switch 80, the key is generated. When the key is provided to the switch 80, it will support an additional 6 APs. In this manner, any certificate may be used to upgrade any switch. And, after the certificate has been assigned to the switch 80 (e.g., the current number has been increased by 6), that certificate may not be re-used with any other switch.

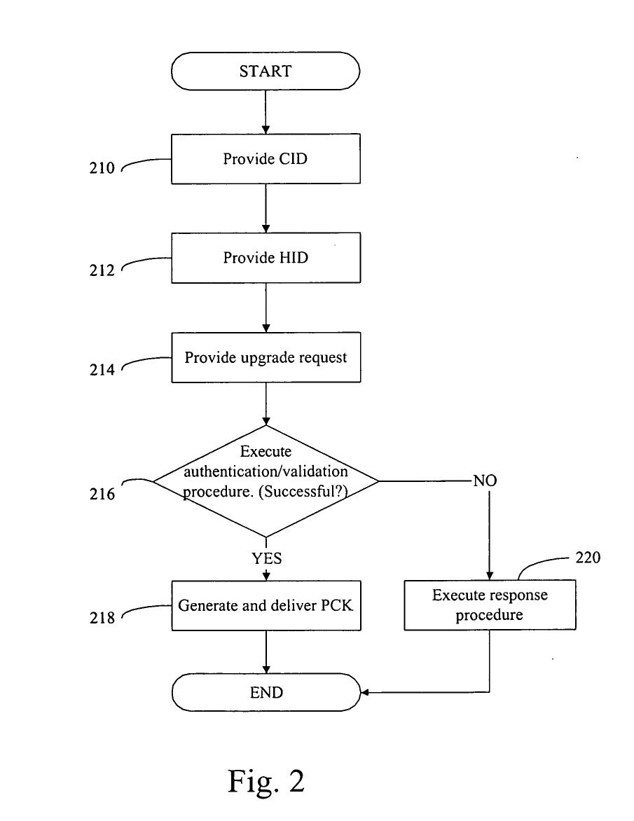

FIG. 2 shows an exemplary embodiment of a method 200 according to the present invention. A user who wishes to upgrade the switch 80 may enter the upgrade request using, for example, the server 32, the MU 50, and/or any device with access to the network 22. For example, the user may enter the request through an Internet web site which is hosted by the server 30. In step 210, the user provides a customer identifier (“CID”). The CID may be a username and/or a password corresponding to the user, and may be stored in the database 40. In other embodiments, the user may not enter the CID until the upgrade request is validated, as will be described below. Thus, the user may remain anonymous until the request is validated. In yet a further embodiment, entering the CID may be optional. Those of skill in the art will understand that the upgrade request may be done via mail and/or by phone.

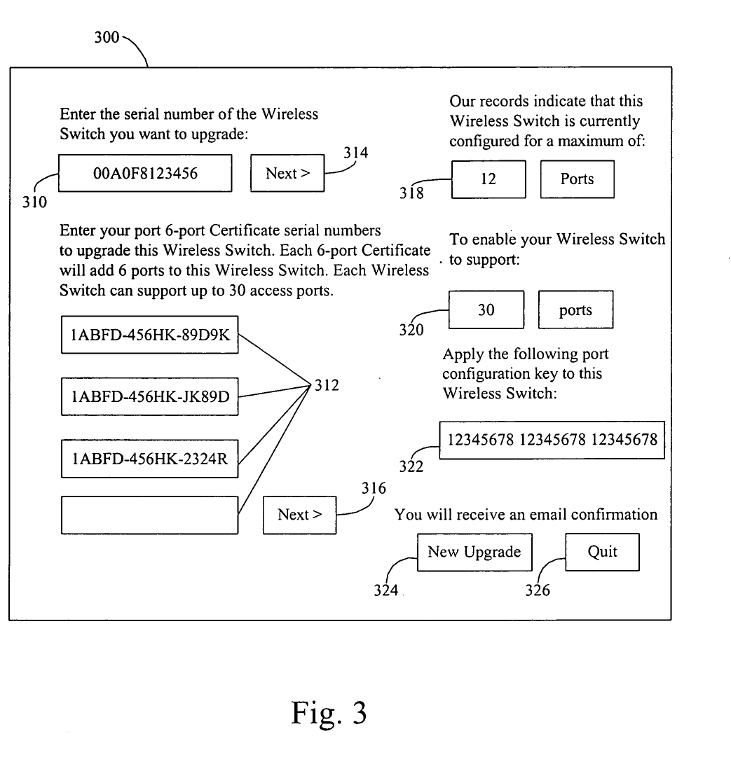

In step 212, the user provides the second data (e.g., a hardware identifier (“HID”) of the switch 80). In one embodiment, this may be done through a text field 310 of an online form 300 as shown in FIG. 3. The HID may be any text string (e.g., an ASCII string) which identifies the switch 80. For example, the HID may be a serial number or a MAC address corresponding to the switch 80. Preferably the HID uniquely identifies the switch 80 in order to facilitate accurate record-keeping. In another embodiment, a barcode on the switch 80 may be scanned, or an RFID embedded in the switch 80 may be read. Within the database 40, the HID may be associated with the current number and all certificate(s) which have been assigned to the switch 80.

In step 214, the user provides the upgrade request. The online form 300 may include a text field for a number of upgrades requested (e.g., a number of licenses, a number of ports to be enabled, etc.). For example, there may be one or more text fields 312 for entering the certificate code corresponding to the upgrade certificate. The certificate code may be manually entered into the online form 300. If the certificate code is a barcode, it may be scanned and inputted to the online form 300. If the certificate code is an RFID, it may be read and inputted to the online form 300. The online form 300 may further include a shipping address field and/or an email address field for transmission of a result of the upgrade request. Alternatively, the shipping address and email address may have been previously stored in the database 40 and matched to the CID. The upgrade request may be transmitted by the user to the server 30 after the online form 300 is completed. For example, as each piece of information is entered, the user may submit the information by activating a submit button 314,316 corresponding to the text field of the information. Alternatively, there may only be a single submit button which the user activates after all the information has been entered. If any of the information is missing or invalid, the server 30 may refuse to process the upgrade request. For example, the server 30 may reload the online form 300 and highlight any field(s) corresponding to the missing/invalid information.

In step 216, the server 30 determines whether the certificate code is valid by performing an algorithm thereon. The server 30 may also check the data of the online form 300 against data stored in the database 40. For example, the server 30 may determine if the HID corresponds to the CID. That is, the server 30 attempts to verify that the user is an owner or an authorized user of the switch 80. Also, the server 30 may determine whether the certificate(s) has been used in a previous upgrade (e.g., already assigned to the switch 80 or any other switch). If the user has not yet entered the CID, the server 30 may prompt the user to do so (e.g., through a message on the web site). The server 30 may also check whether the switch 80 is capable of supporting the upgrade. For example, the server 30 may search the database 40 for a hardware profile corresponding to the HID, and whether the switch 80 has previously been upgraded. For example, the server 30 may search the database 40 for a transaction or upgrade history corresponding to the CID and/or the HID. A payment verification may be executed to determine whether payment can be made for the upgrade request. For example, if the user has not yet been billed for the certificate, the server 30 may verify the user's credit card information, billing account number, etc., and whether the user has enough funds to pay for the upgrade request.

Those skilled in the art will understand that step 216 may be performed prior to the entering of the upgrade request. For example, the server 30 may search the database 40 for the hardware profile and the upgrade history in order to alert the user regarding an upgradeability of the switch 80 before the user enters the upgrade request. The server 30 may also verify that the HID corresponds to the CID prior to the entering of the upgrade request.

In step 218, the server 30 has determined that the upgrade request was successful and generates the upgrade access data (e.g., a port configuration key (“PCK”)). The PCK may be generated by, for example, applying an algorithm upon the HID and/or the current number of APs supported by the switch 80 after the upgrade to produce a pseudo-random text string. The PCK may also be generated as a barcode or in another form which is not directly readable by the user (e.g., stored on an RFID tag). If the PCK is delivered physically, it may be shipped directly to the user. If the PCK is delivered electronically, it may be transmitted directly to the user computer 10. For example, the PCK may be displayed on the online form 300, enabling the user to view the PCK in a text field 322 and/or print a viewable copy thereof. The PCK may also be sent to the user via email. For example, the user may receive an email confirmation after the upgrade request is validated, which includes the PCK in either a body of the email or an email attachment. The PCK may then be applied to the switch 80 in order to complete the upgrade, as will be described below. After the upgrade request is completed, the user may enter additional upgrade requests, or exit the online form 300, as shown by buttons 324 and 326, respectively.

In step 220, the server 30 has determined that the request was unsuccessful. For example, the HID may not correspond to the CID, the switch 80 may not be capable of supporting the upgrade, the user may not have enough funds, the certificate may be expired, have been used or be incompatible with the switch 80, etc. Accordingly, the server 30 executes a response procedure, which may include an alert indicating to the user why the request was unsuccessful. For example, the server 30 may direct the user to an error page containing the alert. The alert may also include a list of instructions which the user may follow in order to validate the request (e.g., verifying that the information on the online form is correct, entering another HID, entering another certificate, etc.). The response procedure may also include an alert to a system administrator. For example, if the user has repeatedly attempted to enter the upgrade request unsuccessfully, the server 30 may prompt the system administrator to investigate why the upgrade request was unable to be validated.

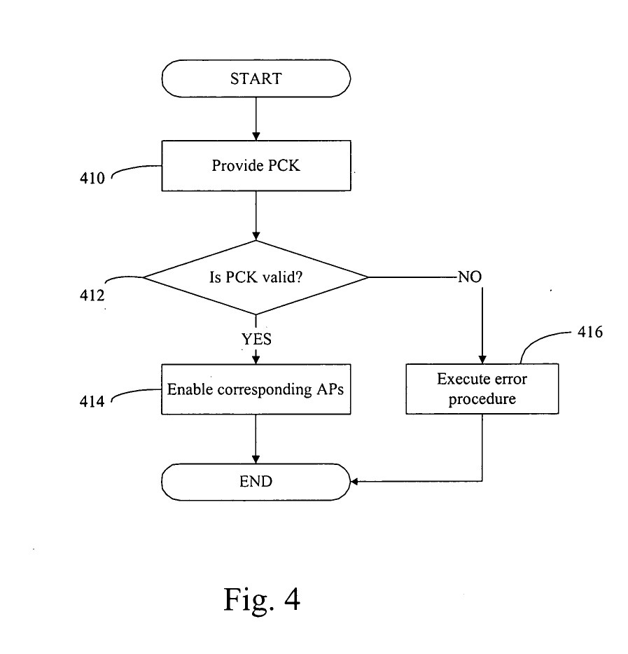

FIG. 4 shows an exemplary embodiment of a method 400 for executing the upgrade of the switch 80 according to the present invention. In step 410, the PCK is provided to the switch 80. For example, if the PCK is the barcode, the user may scan a physical copy (e.g., a print-out) or an electronic copy (e.g., a display screen) of the PCK using the MU 50 when it is coupled to the switch 80 and/or a device (e.g., an image/laser-based scanner or RFID reader) coupled to the user computer 66. If the PCK is the text string, the user may manually input the PCK into a web interface for the switch 80 or a command line interface on the server 32, the MU 50, the user computer 66 and/or the device coupled thereto. The PCK is then transmitted from the server 32 to the switch 80.

In step 412, the switch 80 determines whether the PCK is valid. For example, the switch 80 may perform an algorithm to determine if the PCK is compatible therewith. Thus, the switch 80 is able to determine if the upgrade should be performed. For example, the present invention may be used for security, prevention of unauthorized upgrades and/or unauthorized sharing of software. In another embodiment, the determination of whether the PCK is valid may be performed by the server 32. That is, the server 32 may execute the algorithm on the PCK.

In step 416, the switch 80 has determined that the PCK is invalid and executes an error procedure which may include an error message transmitted to the MU 50, the server 32 and/or the user computer 66. For example, the error message may include a notice that the upgrade was unsuccessful, a list of reasons why the upgrade was unsuccessful and/or a list of possible remedies to attempt. For example, the error message may indicate that the PCK corresponds to another switch, or that the PCK was previously inputted.

In step 414, the switch 80 has determined that the PCK is valid, and completes the upgrade by enabling a predetermined number of APs corresponding to the upgrade request. In one embodiment, the PCK enables the AP(s) by, for example, updating a firmware of the switch 80 to include the PCK. If a plurality of APs are available for enabling, the switch 80 may allow the user to manually select individual APs to enable. For example, if the switch 80 may support 30 APs the PCK enables 6 APs, the switch 80 may allow the user to choose the 6 APs to enable from a among the disabled APs. In addition, the user may not choose to enable a maximum number of APs allowed by the PCK. For example, if the user may enable the 6 additional APs, the user may choose to enable between 0 and 6 APs. Alternatively, the switch 80 may automatically select APs to enable by, for example, selecting consecutively numbered APs starting with a first disabled port which is immediately preceded by a last enabled port.

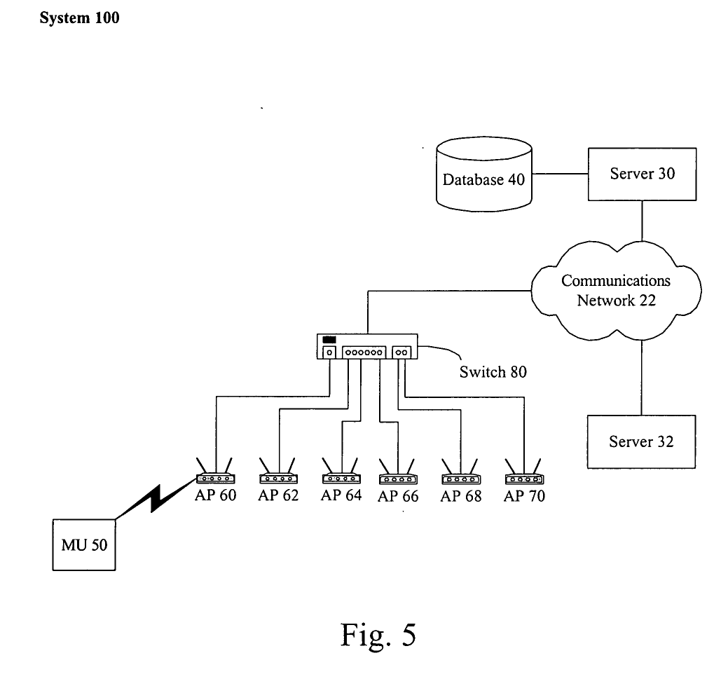

Following the enabling of the APs, the user may utilize the enabled APs. For example, as shown in FIG. 5, the user may attach an additional set of APs (e.g., APs 66,68,70) may be coupled to and communicate with the switch 80. Those skilled in the art will understand that the user may not use all of the additional APs. For example, if the switch 80 has the 6 additional APs enabled, the user may only use 3 APs 66-70 and keep a remaining 3 as reserve APs for use in emergencies. Those skilled in the art will also understand that it may be possible to enable the APs 66-70. Once the additional APs are enabled, the switch 80 may automatically detect the APs 66-70 as being coupled thereto (e.g., plug-and-play).

Although the enabling of the APs has been described with reference to the user inputting the PCK, in another embodiment, the PCK may be transmitted directly to the switch 80 and/or the server 32 from the server 30 after it is generated in step 218 of the method 200.

Those skilled in the art will understand that the present invention may be implemented in any electronic device in which one or more hardware components can be enabled by applying an electronic input to the device. The hardware components may be utilized with other devices (e.g., APs) or as stand-alone components (e.g., storage drives). The present invention presents many advantages, including allowing the user flexibility in being able to choose from a number of upgradeable configurations and allowing manufacturers to streamline production methods as a result of not having to produce multiple versions of the device. In extending a utility of the electronic device, the present invention increases a lifetime and a scalability thereof. Thus, users who often upgrade may experience significant cost savings. The environment may also benefit as a result of less devices being thrown out after their utility has expired.

Advantages of the present invention may further be realized when a purchaser attempts to return the switch 80 to a seller for repairs. For example, after the purchaser has used and/or upgraded the switch 80, the seller may repair the switch 80 and return it to the purchaser in a condition desired by the user (e.g., with upgrades enabled). That is, the seller may examine a database containing a current configuration of the switch 80, and, after repairs, return the switch 80 in the current configuration.

In a further embodiment, the switch 80 may include an RFID chip which has the PCK embedded thereon. In this embodiment, the PCK tells the switch 80 how many APs that the switch 80 may communicate with. To upgrade the switch 80 to support more APs, an RFID writer device may modify the PCK accordingly (e.g., based on a number of APs). That is, as long as the RFID chip in the switch 80 is within a communicable range of the RFID writer, the PCK may be updated to perform the upgrade. Those of skill in the art will understand that this approach, as well as the present invention, may be used to perform an upgrade of a plurality of devices at a single time. That is, if each device includes the RFID chip, they would simply have to be in the communicable range of the RFID writer to be upgraded.

The present invention has been described with reference to the above exemplary embodiments. One skilled in the art would understand that the present invention may also be successfully implemented if modified. Accordingly, various modifications and changes may be made to the embodiments without departing from the broadest spirit and scope of the present invention as set forth in the claims that follow. The specification and drawings, accordingly, should be regarded in an illustrative rather than restrictive sense.

What is claimed is:

1. A network switch, comprising:
a communication arrangement to communicate with a plurality of wireless access ports;
a memory arrangement storing an identifier of the switch and access data corresponding to a first number of the access ports;
a processor allowing communications with the communication arrangement only for the first number of the access ports,
wherein the processor allows communications with the communication arrangement for a second number of the access ports only upon receipt and validation of an upgrade access data which corresponds to the second number and the identifier.

2. The network switch according to claim 1, wherein the communication arrangement includes one of a Ethernet port, a USB port and a serial port.

3. The network switch according to claim 1, wherein the second number is a sum of the first number and a third number of the access ports, the third number of the access ports communicating with the communication arrangement after the validation.

4. The network switch according to claim 3, wherein the third number corresponds to a certificate code.

5. The network switch according to claim 4, wherein the identifier is one of a unique serial number and a MAC address.

6. The network switch according to claim 1, wherein the upgrade access data is a predetermined encrypted key.

7. The network switch according to claim 1, wherein the key is one of (i) a text string, (ii) a barcode and (iii) a message stored on an RFID chip.

8. The network switch according to claim 1, further comprising:
an RFID chip storing the upgrade access data, and
wherein, when the RFID chip receives a predetermined signal, the RFID chip transmits the upgrade access data to the processor.

9. A system, comprising:
a server;
a switch including a communication arrangement, a memory arrangement storing an identifier of the switch, and a processor controlling the communication arrangement to communicate with only a first number of wireless access ports; and
a database coupled to the server, the database storing the identifier and the first number;
wherein, when the server receives a request for the switch to communicate with a second number of the access ports which includes the identifier and the second number, the server generates a predetermined key as a function of the identifier and a third number of the access ports, the third number being a sum of the first number and the second number, and
wherein, when the switch receives the predetermined key, the processor controls the communication arrangement to communicate with the third number of the access ports.

10. The system according to claim 9, wherein the identifier is one of a unique serial number and a MAC address.

11. The system according to claim 9, wherein the second number corresponds to a certificate code.

12. The system according to claim 11, wherein the server validates the request by comparing the certificate code to a list of previously utilized certificate codes, and when the certificate code is found on the list, the server denies the request.

13. The system according to claim 9, wherein the server validates the request by comparing the third number to a total number of the access ports that the communication arrangement may communicate with, and when the third number exceeds the total number, the server denies the request.

14. The system according to claim 9, wherein the predetermined key is at least one of (i) a text string, (ii) a barcode and (iii) a message on an RFID chip.

15. The system according to claim 9, wherein the predetermined key is stored on an RFID chip coupled to the processor.

16. The system according to claim 15, wherein, when the RFID chip receives a predetermined signal from the server, the RFID chip transmits the predetermined key to the processor.

17. A method, comprising:
communicating with a first number of wireless access ports by a communication arrangement of a switch, the switch further including a memory arrangement storing an identifier of the switch, and a processor controlling the communication arrangement;
receiving, by a server, a request for the switch to communicate with a second number of the access ports, the request includes the identifier and the second number, the server coupled to a database which stores the identifier and the first number;
generating, by the server, a predetermined key as a function of the identifier and a third number of the access ports, the third number being a sum of the first number and the second number,
when the processor receives the predetermined key, allowing the communication arrangement to communicate with the third number of the access ports.

18. The method according to claim 17, wherein the identifier is one of a unique serial number and a MAC address.

19. The method according to claim 17, further comprising:
validating the request by the server.

20. The method according to claim 19, wherein the second number corresponds to a certificate code.

21. The method according to claim 20, wherein the validating step includes the following substeps:
comparing, by the server, the certificate code to a list of previously utilized certificate codes; and
when the certificate code is found on the list, denying the request by the server.

22. The method according to claim 17, wherein the validating step includes the following substeps:
comparing, by the server, the third number to a total number of the access ports that the communication arrangement may communicate with;
when the third number exceeds the total number, denying the request by the server.

23. The method according to claim 17, wherein the predetermined key is at least one of (i) a text string, (ii) a barcode and (iii) a message on an RFID chip.

24. The method according to claim 17, wherein the predetermined key is stored on an RFID chip coupled to the processor.

25. The method according to claim 24, further comprising:
when the RFID chip receives a predetermined signal, transmitting, by the RFID chip, the predetermined key to the processor.
